(19) United States
(12) Patent Application Publication
(10) Pub. No.: US 2026/0369830 A1
(43) Pub. Date: Nov. 19, 2026

(54) ELECTRODE AND SECONDARY BATTERY

(71) Applicant: SAMSUNG SDI CO., LTD., Yongin-si (KR)

(72) Inventor: Sung Min CHO, Suwon-si (KR)

(21) Appl. No.: 19/675,672

(22) Filed: May 13, 2026

(30) Foreign Application Priority Data
May 14, 2025 (KR) 10-2025-0062585

(51) Int. Cl. H01M 50/534; H01M 10/42; H01M 50/533; H01M 50/536

(52) U.S. Cl. CPC H01M 50/534; H01M 10/4235; H01M 50/533; H01M 50/536

(57) ABSTRACT

An electrode includes a substrate and a mixture layer formed on a first portion of the substrate. The electrode also includes a tab having a first end portion provided on a second portion of the substrate and a second end portion spaced from the substrate, wherein the tab includes one or more elastic members.

### CROSS-REFERENCE TO RELATED APPLICATION

The present application claims priority to and the benefit of Korean Patent Application No. 10-2025-0062585, filed on May 14, 2025, in the Korean Intellectual Property Office, the entire disclosure of which is incorporated herein by reference.

### BACKGROUND

### 1. Field

The present disclosure relates to an electrode and a secondary battery.

### 2. Discussion of Related Art

Secondary batteries can be discharged and then recharged, unlike primary batteries that cannot be recharged. Low-capacity secondary batteries are used in small portable electronic devices such as smartphones, feature phones, notebook computers, digital cameras, and camcorders. Large-capacity secondary batteries are widely used as power sources for driving motors in hybrid vehicles, electric vehicles, and as power storage batteries. These secondary batteries include a positive electrode and a negative electrode, an electrode assembly including the electrode, a case in which the electrode assembly is accommodated, and an electrode terminal connected to the electrode assembly.

The electrode includes a substrate and a mixture layer formed on the substrate. The mixture layer includes an active material. The electrode also includes a tab attached to the substrate. The electrode assembly including the electrode may be wound to form, for example, a jelly-roll shape.

When the secondary battery is charged, the electrode may expand. As the electrode expands, it may press against another electrode and/or an adjacent separator or the electrode may receive a force from another electrode and/or the separator. Accordingly, the substrate may be deformed.

As the demand for high-capacity secondary batteries has increased in recent years, substrates have been made thinner. And cracks occur more easily in the thinner substrates. When cracks occur in the electrode, the resistance of the secondary battery increases, heat is generated around the cracks, and/or the capacity of the secondary battery decreases, thereby reducing the reliability of the secondary battery.

The information disclosed in this section is only intended to improve understanding of the background of the present disclosure and therefore may include information that does not constitute related or prior art.

### SUMMARY

An embodiment of the present disclosure is directed to providing an electrode including an elastic member and a secondary battery including the electrode.

An embodiment of the present disclosure is also directed to providing an electrode including two tabs and/or a secondary battery including the electrode.

In one example, the electrode may include two tabs disposed to face each other with a substrate interposed therebetween.

However, the technical problem to be solved by the present disclosure is not limited to the above-mentioned problems, and other problems not mentioned will be clearly understood by those skilled in the art from the following description.

According to an aspect of the present disclosure, there is provided an electrode including: a substrate; a mixture layer formed on a first portion of the substrate; and a tab having a first end portion provided on a second portion of the substrate and a second end portion spaced from the substrate, wherein the tab includes one or more elastic members.

The tab may include a conductive member that is electrically conductive with the substrate, and one or more grooves formed in the conductive member and into which the one or more elastic members are inserted.

The one or more elastic members may include a first elastic member that forms a part of a contact surface between the substrate and the tab.

The elastic member may form a part of an edge of the contact surface between the substrate and the tab.

The elastic member may be positioned at the first end portion of the tab.

The first member may be positioned at a side of the tab.

The elastic member may include a second elastic member positioned at a second side of the tab.

The second elastic member may be spaced from the contact surface between the substrate and the tab.

The second elastic member may form a part of the contact surface between the substrate and the tab.

The tab may include a bonded region bonded to the substrate and a non-bonded region where the one or more elastic members are positioned, wherein the non-bonded region is positioned closer to the first end portion of the tab than the bonded region is to the first end portion of the tab.

The one or more elastic members may include a plurality of elastic members extending from a first side of the tab in a width direction of the tab, and one or more elastic members extending from a second side of the tab in the width direction of the tab and alternately disposed with the third elastic members.

The tab may be bonded to the substrate at a bonded portion formed in a longitudinal direction of the tab, and the elastic member may include an elastic member positioned on a first side of the bonded portion and extending in a width direction of the tab from a first side of the tab, and an elastic member positioned on a second side of the bonded portion and extending in the width direction of the tab from a second side of the tab.

The elastic member may be formed with a thickness that is less than or equal to a thickness of the tab.

The tab may be formed with a thickness of 1 mm or less.

The tab may include a first tab provided on a first surface of the substrate and a second tab provided on a second surface of the substrate and positioned corresponding to the first tab with the substrate interposed therebetween.

According to another aspect of the present disclosure, there is provided a secondary battery including: a case, an electrode assembly accommodated in the case, with the electrode assembly including a first electrode, a second electrode, and a separator provided between the first electrode and the second electrode, wherein one or both of the first electrode and the second electrode includes: a substrate; a mixture layer formed on a first portion of the substrate; and a tab having a first end portion provided on a second portion of the substrate and a second end portion spaced from the substrate, and the tab includes one or more elastic members.

The one or more elastic members may include an elastic member that forms a part of a contact surface between the substrate and the tab.

The elastic member may form a part of an edge of the contact surface between the substrate and the tab.

The one or more elastic members may include a first elastic member extending from a first side of the tab in a width direction of the tab and a second elastic member extending from a second side of the tab in the width direction of the tab.

For example, the tab may include a first tab provided on a first surface of the substrate and a second tab provided on a second surface of the substrate and corresponding to the first tab with the substrate interposed therebetween.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings.

FIG. 1 is a cross-sectional view of a secondary battery according to an embodiment of the present disclosure;

FIG. 2 is a schematic view of an electrode according to an embodiment of the present disclosure;

FIG. 3 is a schematic view of an electrode according to an embodiment of the present disclosure;

FIG. 4 is a schematic view of an electrode according to an embodiment of the present disclosure;

FIG. 5 is a cross-sectional view of a tab taken along line A-A’ in FIG. 4 according to an embodiment of the present disclosure;

FIG. 6 is a cross-sectional view of a tab taken along line B-B’ in FIG. 4 according to an embodiment of the present disclosure;

FIG. 7 is a cross-sectional view of the tab taken along line B-B’ in FIG. 4 according to an embodiment of the present disclosure;

FIG. 8 is a schematic view illustrating an electrode according to an embodiment of the present disclosure;

FIG. 9 is a cross-sectional view of a tab taken along line C-C’ in FIG. 8 according to an embodiment of the present disclosure;

FIG. 10 is a cross-sectional view of a tab taken along line D-D’ in FIG. 8 according to an embodiment of the present disclosure;

FIG. 11 is a cross-sectional view of a tab taken along line D”-D”’ in FIG. 8 according to an embodiment of the present disclosure;

FIG. 12 is a schematic view illustrating an electrode according to an embodiment of the present disclosure;

FIG. 13 is a cross-sectional view of a tab taken along line E-E’ in FIG. 12 according to an embodiment of the present disclosure;

FIG. 14 is a schematic view illustrating an electrode according to an embodiment of the present disclosure;

FIG. 15 is a cross-sectional view of a tab taken along line F-F’ in FIG. 14 according to an embodiment of the present disclosure; and

FIG. 16 is a cross-sectional view of a tab taken along line F”-F”’ in FIG. 14 according to an embodiment of the present disclosure.

### DETAILED DESCRIPTION OF EXEMPLARY EMBODIMENTS

Hereinafter, preferred embodiments of the present invention will be described in detail with reference to the accompanying drawings. The terms or words used in the specification and claims should not be interpreted as limited to their usual or dictionary meanings, and should be interpreted in meanings and concepts that are consistent with the technical concept of the present invention based on the principle that the present inventor can appropriately define the concepts of the terms in order to explain his or her invention in its best way. Accordingly, it should be understood that the configurations shown in the drawings and the embodiments described herein are only preferred embodiments of the present disclosure and are not intended to represent all of the technical ideas of the disclosure, and that there may be various equivalents and modifications that may be substituted for them at the time of this application.

In addition, when used herein, the terms “comprise,” and “include,” and/or “comprising,” and “including” specify the presence of stated features, numbers, steps, operations, members, elements and/or groups thereof, but do not exclude the presence or addition of one or more other features, numbers, operations, members, elements and/or groups thereof.

In addition, to aid understanding of the disclosure, the accompanying drawings are not necessarily drawn to scale and the dimensions of some components may be exaggerated. In addition, the same reference numbers may be assigned to the same components in different embodiments.

When two things being compared are said to be “same”, it means they are “substantially the same.” Therefore, “substantially the same” may include deviations that are considered low in the art, for example, deviations of less than 5%. In addition, uniformity of a parameter in a given area may imply uniformity from an average point of view.

Although “first,” “second,” and the like are used to describe various components, these components are not limited by these terms. These terms are used only to distinguish one component from another, and unless specifically stated otherwise, it is to be understood that a first component may also be a second component.

Throughout the specification, unless specifically stated otherwise, each element may be singular or plural.

The arrangement of an arbitrary component on the "upper portion (or lower portion)" of a component or "above (or below)" the component means that the arbitrary component is not only disposed in contact with the upper surface (or lower surface) of the component, but also other components may be interposed between the component and the arbitrary component disposed on (or under) the component.

In addition, when a component is described as being "connected," "coupled," or "linked" to another component, it is to be understood that the components may be directly coupled or connected to one another, but that other components may be "interposed" between the components, or that each component may be "connected," "coupled," or "linked" through another component. In addition, when a part is "electrically coupled" to another part, this includes not only the case where it is "directly connected" but also the case where it is "coupled" with another member or element interposed therebetween.

Whenever reference is made throughout the specification to “A and/or B,” this means A, B or A and B, unless otherwise specified. That is, “and/or” includes all or any combination of the listed items. When “C to D” is described, this means C or more and D or less, unless otherwise specified.

The terminology used herein is for the purpose of describing embodiments of the present disclosure and is not intended to be limiting of the present disclosure.

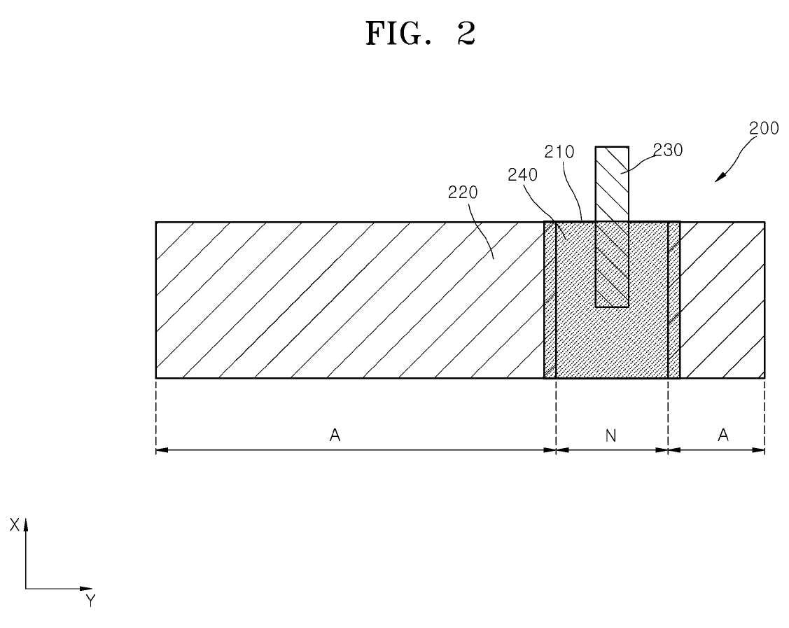

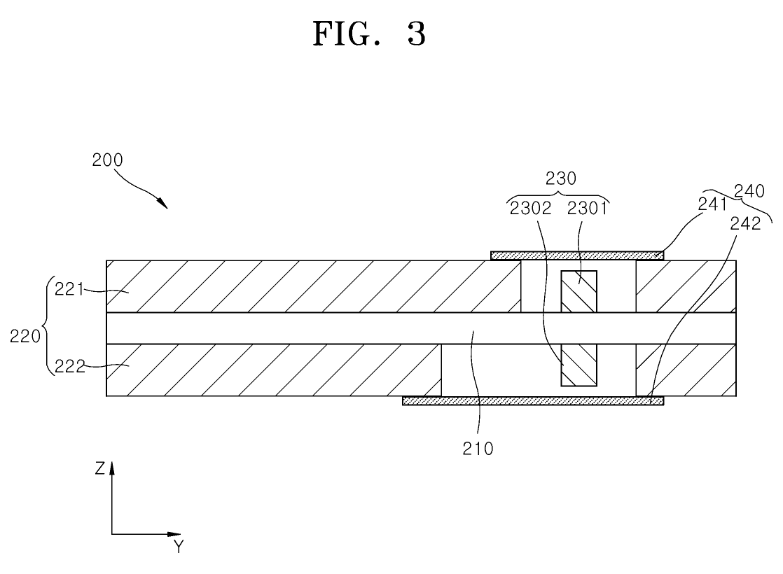

In the present specification, a Z-axis represents a thickness direction of a tab 230 (see FIG. 3). In the present specification, an X-axis represents a longitudinal direction of the tab 230, with the X-axis being perpendicular to the Z-axis. A Y-axis represents a width direction of the tab 230 (see FIG. 2). The Y-axis is perpendicular to the Z-axis and to the X-axis.

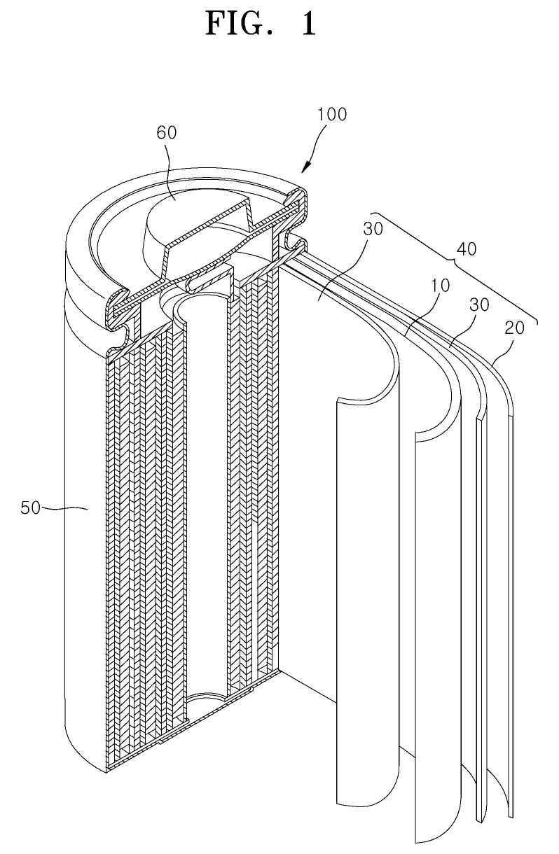

FIG. 1 is a cross-sectional view of a secondary battery according to an embodiment of the present disclosure.

As illustrated in FIG. 1, a secondary battery 100 may include a case 50, an electrode assembly 40, and a cap assembly 60. The secondary battery 100 may further include a center pin (not shown) in some examples. As the cap assembly 60 performs a current interruption operation, it may also referred to as a current interruption device.

The case 50 is formed in a cylindrical shape. The case 50 may include a roughly circular bottom portion and a cylindrical side wall extending a certain length upward from the circumference of the bottom portion.

During a process of making the secondary battery 100, an upper part of the case 50 is open. During an assembly process of the secondary battery 100, the electrode assembly 40 and the center pin may be inserted into the case 50 together with an electrolyte. The case 50 may be made from, for example, steel, stainless steel, aluminum, an aluminum alloy, or an equivalent thereof. But the present disclosure is not limited to these examples.

The case 50 is not limited to the depicted configuration, and the case 50 may be configured in various shapes such as a circular shape, pouch shape, or the like. In some examples, the case 50 may be made of a metal such as aluminum, an aluminum alloy, nickel-plated steel, and a laminated film, or plastic forming a pouch.

The electrode assembly 40 may be accommodated in the case 50. The electrode assembly 40 may include a first electrode 10, a second electrode 20, and a separator 30 positioned between the first electrode 10 and the second electrode 20. The separator 30 is configured to prevent a short circuit between the first electrode 10 and the second electrode 20 while allowing the movement of lithium ions.

The first electrode 10 may be a positive electrode or a negative electrode. And the second electrode 20 may be a negative electrode or a positive electrode and have a different polarity from the first electrode 10. The positive electrode may be formed by coating a positive electrode active material (e.g., a transition metal oxide (LiCoO₂, LiNiO₂, LiMn₂O₄, etc.)) on a positive electrode current collector plate. The negative electrode may be formed by coating a negative electrode active material (e.g., graphite, carbon, etc.) on a negative electrode current collector plate.

In some examples, the electrode assembly 40 may be formed by winding the first electrode 10, the second electrode 20, and the separator 30 into a roughly cylindrical shape. However, the shape of the electrode assembly 40 is not limited thereto.

The cap assembly 60 is coupled to the case 50 to close the opening and seal the electrode assembly 40 inside the case 50.

As described above, the electrode assembly 40 includes the first electrode 10, the second electrode 20, and the separator 30 positioned between the first electrode 10 and the second electrode 20. In addition, the electrode assembly 40 is accommodated in the case 50 together with an electrolyte. Hereinafter, the electrode assembly 40 and the electrolyte will be described in detail.

### Positive electrode

As the positive electrode active material, a compound capable of reversible intercalation and deintercalation of lithium (lithiated intercalation compound) may be used. Specifically, at least one composite oxide of lithium and a metal selected from cobalt, manganese, nickel, and a combination thereof may be used.

The composite oxide may be a lithium transition metal composite oxide, and specific examples thereof include lithium nickel-based oxides, lithium cobalt-based oxides, lithium manganese-based oxides, lithium iron phosphate-based compounds, cobalt-free nickel-manganese-based oxides, or a combination thereof. In some examples, a compound represented by any one of the following chemical formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹ _{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); and LiₐFePO₄(0.90≤a≤1.8). In these chemical formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer includes a positive electrode active material and may further include a binder and/or a conductive material.

The amount of the positive electrode active material may be 90 wt% to 99.5 wt% with respect to 100 wt% of the positive electrode active material layer. The amounts of the binder and conductive material may be 0.5 wt% to 5 wt%, respectively, based on 100 wt% of the positive electrode active material layer.

Aluminum may be used as the current collector, but the present disclosure is not limited thereto.

### Negative electrode

The negative electrode active material includes a material capable of reversibly intercalating/deintercalating lithium ions, a lithium metal, an alloy of lithium metal, a material capable of doping and dedoping lithium, or a transition metal oxide.

The material capable of reversibly intercalating/deintercalating the lithium ions may be a carbon-based negative electrode active material, for example, crystalline carbon, amorphous carbon, or a combination thereof. Examples of the crystalline carbon include graphite such as natural graphite or artificial graphite, and examples of the amorphous carbon include soft carbon or hard carbon, mesophase pitch carbide, calcined coke, and the like.

As the material capable of doping and dedoping the lithium, a Si-based negative electrode active material or a Sn-based negative electrode active material may be used. The Si-based negative electrode active material may be silicon, a silicon-carbon composite, SiOₓ (0 < x < 2), a Si-based alloy, or a combination thereof.

The silicon-carbon composite may be a composite of silicon and amorphous carbon. According to an embodiment, the silicon-carbon composite may be in the form of silicon particles and amorphous carbon coated on the surface of the silicon particles.

The silicon-carbon composite may further include crystalline carbon. For example, the silicon-carbon composite may include a core including crystalline carbon and silicon particles and an amorphous carbon coating layer positioned on the surface of the core.

A negative electrode for a lithium secondary battery cell 100 includes a current collector and a negative electrode active material layer positioned on the current collector. The negative electrode active material layer includes a negative electrode active material and may further include a binder and/or a conductive material.

In some examples, the negative positive active material layer may include 90 to 99 wt% of the negative positive active material, 0.5 to 5 wt% of the binder, and 0 to 5 wt% of the conductive material.

The binder may be a non-aqueous binder, an aqueous binder, a dry binder, or a combination thereof. When using an aqueous binder as the negative electrode binder, a cellulose-based compound capable of imparting viscosity may be further included.

The negative electrode current collector may be formed from a copper foil, a nickel foil, a stainless steel foil, a titanium foil, a nickel foam, a copper foam, a polymer substrate coated with a conductive metal, and a combination thereof.

### Separator

Depending on the type of the lithium secondary battery cell 100, a separator may be present between the positive and negative electrodes. As such a separator, polyethylene, polypropylene, polyvinylidene fluoride or a multilayer film of two or more thereof may be used.

The separator 30 may include a porous substrate, and a coating layer including an organic material, an inorganic material, or a combination thereof located on one surface or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃,SrTiO₃, BaTiO₃, Mg(OH)₂, boehmite, and a combination thereof. But the present disclosure is not limited thereto.

The organic material and inorganic material may be mixed and present in one coating layer, or may be present in a laminated form with a coating layer including the organic material and a coating layer including the inorganic material.

### Electrolyte

The electrolyte for the secondary battery 100 may include a non-aqueous organic solvent and a lithium salt.

The non-aqueous organic solvent may serve as a medium through which ions involved in the electrochemical reaction of the battery may move. The non-aqueous organic solvent may be a carbonate-based, an ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and the like.

The ester-based solvent may include methyl acetate, ethyl acetate, n-propyl acetate, dimethyl acetate, methyl propionate, ethyl propionate, decanolide, mevalonolactone, valerolactone, caprolactone, and the like.

The ether-based solvent may include dibutyl ether, tetraglyme, diglyme, dimethoxyethane, 2-methyltetrahydrofuran, 2,5-dimethyltetrahydrofuran, tetrahydrofuran, and the like. In addition, the ketone-based solvent may include cyclohexanone, and the like. As the alcohol-based solvent, ethyl alcohol, isopropyl alcohol, and the like may be used, and as the aprotic solvent, a nitrile such as R-CN (R is a straight, branched, or ring-shaped hydrocarbon group having 2 to 20 carbon atoms, and may include a double bond, an aromatic ring, or an ether group), an amide such as dimethylformamide, a dioxolane such as 1,3-dioxolane or 1,4-dioxolane, a sulfolane, and the like may be used.

The non-aqueous organic solvent may be used alone or in a combination of two or more.

In addition, when using the carbonate-based solvent, a cyclic carbonate and a chain carbonate may be mixed and used, and the cyclic carbonate and the chain carbonate may be mixed in a volume ratio of 1:1 to 1:9.

The lithium salt is dissolved in the organic solvent and acts as a source of lithium ions within the battery, thereby enabling the basic operation of the secondary battery and promoting the movement of lithium ions between the positive electrode and the negative electrode. Representative examples of the lithium salt may include LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI)), LiC₄F₉SO₃, LiN(CₓF₂ₓ₊₁SO₂)(C_{y}F_{2y+1}SO₂) (x and y are integers from 1 to 20), lithium trifluoromethanesulfonate, lithium tetrafluoroethanesulfonate, lithium difluorobis(oxalato)phosphate (LiDFOB), and lithium bis(oxalato)borate (LiBOB).

Hereinafter, the electrode included in the secondary battery 100 according to an embodiment of the present disclosure will be described in more detail. The electrode may include a first electrode 10 and/or a second electrode 20.

FIG. 2 is a view of an electrode according to an embodiment of the present disclosure.

The electrode 200 may correspond to the first electrode 10 shown in FIG. 1 and/or the second electrode 20 shown in FIG. 1.

The electrode 200 includes a substrate 210, a mixture layer 220, and a tab 230. And the electrode 200 may further include a protective layer 240. However, the components included in the electrode 200 are not limited to those illustrated in FIG. 2, and the electrode 200 may include only some of the components illustrated in FIG. 2 and/or may further include additional components in addition to the components illustrated in FIG. 2.

The substrate 210 may include the current collector as described above with reference to FIG. 1. When the electrode 200 is a positive electrode, the substrate 210 may include a positive electrode current collector, and the positive electrode current collector may include aluminum (Al). When the electrode 200 is a negative electrode, the substrate 210 may include a negative electrode current collector, and the negative electrode current collector may include copper (Cu).

The mixture layer 220 may include an active material. When the electrode 200 is a positive electrode, the active material includes a positive electrode active material. When the electrode 200 is a negative electrode, the active material includes a negative electrode active material.

The mixture layer 220 may further include a binder and/or a conductive material. The mixture layer 220 may be coated by being applied on the substrate 210 in the form of a slurry including an active material. Alternatively, the mixture layer 220 may be attached to the substrate 210 in the form of a freestanding film including an active material.

The mixture layer 220 may be provided on a portion of the substrate 210. For example, the mixture layer 220 may be provided on a portion of one surface of the substrate 210. Alternatively, for example, the mixture layers 220 may be provided on both surfaces of the substrate 210. A region where the mixture layer 220 is provided on a portion of the substrate 210 is referred to as a coated portion A. A region of the substrate 210 where the mixture layer 220 is not provided and the substrate 210 is exposed may be referred to as an uncoated portion N.

The tab 230 may be provided to the substrate. For example, a first end portion of the tab 230 is attached to the substrate 210, with the tab 230 extending from the first end portion to a second end portion. Here, the direction from the first end portion to the second end portion is shown as a direction of the X-axis in FIG. 2. That is, the direction from the first end portion to the second end portion of the tab 230 may be a longitudinal direction of the tab 230. Accordingly, the second end portion of the tab 230 is not attached to the substrate 210, but extends outward from the substrate 210.

The tab 230 may be a middle tab where the mixture layer 220 is provided on both sides of the tab 230 as illustrated in FIG. 2. In other embodiments, the tab 230 may be attached to an end of the substrate 210. In this way, the tab 230 includes different types wherein at least one side is provided on the substrate 210.

The tab 230 provides a path through which the electrode 200 may be electrically connected to outside of a battery. As such, the tab 230 includes a conductive material, for example, a metallic material. With this configuration, electrons may move along the tab 230 to the electrode 200 or move from the electrode 200 to the outside through the tab 230.

The second end portion of the tab 230 may be electrically connected to other components. For example, the second end portion of the tab 230 may be electrically connected to a current collector plate, a cap plate, the cap assembly 60, the case 50, or the like to electrically connect them to the electrode 200.

The tab 230 may be attached to the substrate 210. For example, the tab 230 may be attached to the substrate 210 via a conductive tape or an adhesive material. Alternatively, when the tab 230 includes a metallic material, the tab 230 may be attached to the substrate 210 through welding. The welding may include ultrasonic welding, laser welding, high-frequency welding, etc.

As illustrated in FIG. 2, the tab 230 may be formed in a rectangular plate shape. Alternatively, for example, the tab 230 may be formed in a plate shape, with a first end portion formed as a curved surface and a second end portion formed as a plane having a linear shape. In other embodiments, the tab 230 may be formed in a plate shape, with the first and second end portions formed as curved surfaces. In still further embodiments, the tab 230 may be formed in a plate shape, with an end portion formed in a pointed shape formed by two planes meeting. However, the shape of the tab 230 is not limited to these examples.

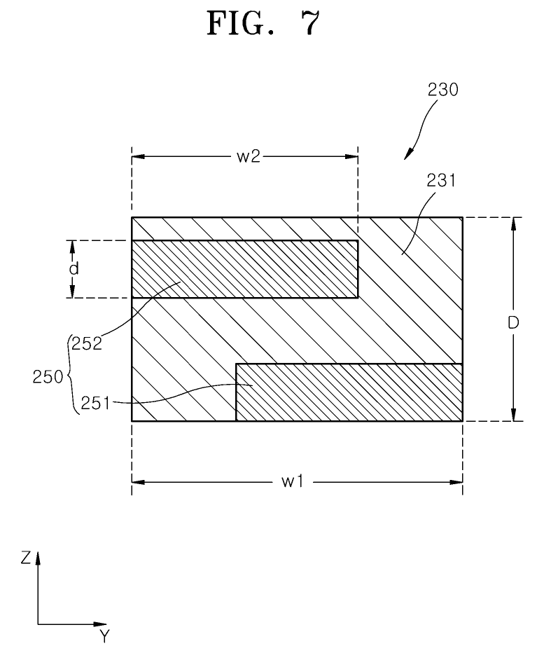

The tab 230 further includes one or more elastic members 250 (see FIG. 7). In one example, the tab 230 may include an elastic member 250 positioned at a portion of a contact surface that contacts the substrate 210. In such a configuration, the elastic member 250 absorbs the force of the tab 230 pressing towards the substrate 210. That is, the elastic member 250 may alleviate a force that the tab 230 would otherwise press against the substrate 210.

The protective layer 240 may be provided on the substrate 210 and cover the tab 230. During charging and discharging processes, the electrode 200 may damage an adjacent electrode and/or the separator 30. As such, a short circuit may occur between the electrodes 200 and/or the lifetime of the secondary battery 100 may be reduced. But the protective layer 240 may protect the electrode 200 from these risks. The protective layer 240 may prevent at least a portion of the electrode 200 from being damaged by external pressure. The protective layer 240 may be provided on the uncoated portion N. Alternatively, the protective layer 240 may be provided on the uncoated portion N and may extend from the uncoated portion N to also be provided on a portion of the coated portion A.

The protective layer 240 may include an insulating material. For example, the protective layer 240 may include at least one of polyimide (PI), polysulfone, polyurethane (PU), polyamide (PA), 6,6 nylon, polycarbonate (PC), polytetrafluoroethylene (PTFE), polymethyl methacrylate (PMMA), polyethylene terephthalate (PET), and combinations thereof.

Although not shown in FIG. 2, the protective layer 240 may further include an adhesive layer for attachment to the substrate 210 and/or the tab 230. The adhesive layer may be located between the protective layer 240 and the substrate 210 and/or the tab 230. The adhesive layer may include an adhesive material such as a silicone-based resin, an acrylic-based resin, a urethane-based resin, a rubber-based resin, an epoxy resin, a polyolefin, and combinations thereof.

FIG. 3 is a schematic view of an electrode according to an embodiment of the present disclosure. An electrode 200 according to an embodiment of the present disclosure (for example, including the electrode 200 described in FIGS. 1 and 2) includes a substrate 210, a mixture layer 220, and a tab 230. The electrode 200 may further include a protective layer 240.

As described above, the mixture layer 220 may be provided on one or both surfaces of the substrate 210. FIG. 3 illustrates an example in which the mixture layers 220 are provided on both surfaces of the substrate 210. However, this is merely an example, and in other embodiments the mixture layer 220 may be provided on only one surface of the substrate 210.

The mixture layer 220 may include a first mixture layer 221 provided on a surface A of the substrate 210 and a second mixture layer 222 provided on a surface B of the substrate 210. Here, the surface A and the surface B correspond to opposite sides of the substrate 210. The first mixture layer 221 and the second mixture layer 222 may be positioned with the substrate 210 interposed therebetween.

As shown in FIG. 2, the tab 230 may include an elastic member 250 (see FIG. 7). When the tab 230, which is formed of a metallic material, is thin, there may be a problem in that the tab 230 sags. However, in the tab 230 according to embodiments of the present disclosure, the overall shape of the tab 230 may be supported through the elastic member 250. Accordingly, the tab 230 may be formed with a relatively thin thickness compared to conventional tabs. In some examples, each of the tabs 230 may be formed to be 0.1 mm or less. Alternatively, for example, each of the tabs 230 may be formed to be 0.09 mm or less, each of the tabs 230 may be formed to be 0.08 mm or less, each of the tabs 230 may be formed to be 0.07 mm or less, each of the tabs 230 may be formed to be 0.06 mm or less, or each of the tabs 230 may be formed to be 0.05 mm or less.

Accordingly, with the reduced thickness tab 230, impacts may be cushioned by the provisions of the elastic member 250 to thereby reduce the force applied to the substrate 210 by a step by being formed with a thin thickness, and/or disperse the pressing force by being formed as a pair.

The electrode 200 may include one or more tabs 230. For example, the electrode 200 may include a pair of tabs 2301 and 2302 provided on opposite sides of the substrate 210. FIG. 3 illustrates an example in which the electrode 200 includes two tabs 230. However, embodiments of the present disclosure are not limited thereto, and the electrode 200 may include one tab 230 or may include three or more tabs 230.

The tab 230 may include a first tab 2301. The first tab 2301 may be provided on the surface A of the substrate 210. The tab 230 may include a second tab 2302, with the second tab 2302 being provided on the surface B of the substrate 210.

A first end portion of the first tab 2301 is provided on the surface A of the substrate 210, and a second end portion of the first tab 2301 may extend from the substrate 210. A first end portion of the second tab 2302 is provided on the surface B of the substrate 210, and a second end portion of the second tab 2302 may extend from the substrate 210. The first tab 2301 and the second tab 2302 may extend in the same direction from the substrate 210. The second end portion of the first tab 2301 and the second end portion of the second tab 2302 may face each other while being spaced apart from each other. For example, the second end portion of the first tab 2301 and the second end portion of the second tab 2302 may be spaced apart from each other by a thickness of the substrate 210.

The first tab 2301 and the second tab 2302 may correspond to each other with the substrate 210 therebetween. The tab 230 may have an increased contact area with the substrate 210 by positioning the first tab 2301 and the second tab 2302 to correspond to each other. The tab 230 may allow the pressure that was applied only to one surface of the substrate 210 to be shared by both surfaces of the substrate 210. In this way, because the pressure by the tab 230 is distributed to both surfaces of the substrate 210, cracks may be prevented from occurring in the substrate 210. Therefore, the electrode 200 may have a reduced resistance and/or an increased output.

As shown in FIG. 7, the tab 230 may include the elastic member 250 therein. The elastic member 250 may form a part of the contact surface where the substrate 210 and the tab 230 contact each other. The elastic member 250 may relieve the force that the tab 230 applies to the substrate 210.

In one example, the elastic member 250 may form a part of an edge of the contact surface where the substrate 210 and the tab 230 contact each other. When the tab 230 presses against the substrate 210, the edge of the contact surface where a step is formed between the tab 230 and the substrate 210 may receive the greatest force. The elastic member 250 may more directly relieve the force that the tab 230 exerts on the substrate 210 by forming a part of the edge of the contact surface.

The elastic member 250 may be located on sides of the tab 230, i.e., a side portion of the tab 230. The side portion of the tab 230 forms a step with the substrate 210 and corresponds to the edge of the contact surface. The elastic member 250 may relieve the force exerted by the tab 230 on the substrate 210 by absorbing an impact from the side portion of the tab 230.

In one example, the elastic member 250 may be positioned at an end portion of the tab 230 that applies the greatest pressure on the substrate 210. Thus, the elastic member 250 may effectively reduce the pressure applied to the substrate 210 by being located at the one end portion of the tab 230.

In other embodiments, the elastic member 250 may not form a contact surface between the substrate 210 and the tab 230. That is, the elastic member 250 may be spaced from the substrate 210. In such embodiments, the elastic member 250 may absorb the force applied to the tab 230 and thereby relieve the impact applied to the tab 230.

The elastic member 250 may include an elastic material that absorbs the force applied to the tab 230 and may relieve the impact applied to the substrate 210 by the tab 230. The elastic material may include a rubber-based resin such as natural rubber or synthetic rubber. Alternatively, the elastic material may include a urethane-based resin such as polyurethane or an elastic fiber. For example, the elastic fiber may include a polyurethane elastic fiber, a polyester-ether elastic fiber, a polyester elastic fiber, an olefin elastic fiber such as XLA, a rigid elastic fiber, a biocomponent fiber, a shape memory fiber, etc.

In some examples, the elastic member 250 may include a conductive polymer. The conductive polymer may include, for example, at least one of polythiophene-based conductive polymers, polypyrrole, polyphenylene, polyaniline, polyacetylene, polysulfonitride, and combinations of at least two thereof. For example, the polythiophene-based conductive polymer may include polyethylenedioxythiophene (PEDOT), polyethylenedioxythiophene/polycellulose sulfonate (PEDOT/PCS), etc.

When the tabs 230 are provided on both surfaces of the substrate 210, the protective layers 240 may also be provided on both surfaces of the substrate 210 to protect the tabs 230. As such, the protective layer 240 may include a first protective layer 241 provided on the surface A of the substrate 210 while covering the first tab 2301 and a second protective layer 242 provided on the surface B of the substrate 210 while covering the second tab 2302.

Hereinafter, the tab 230 in the structure of the electrode 200 is described in more detail. Only one surface (for example, the surface A) of the electrode 200 will be described. However, the contents described below may be equally applied to one surface or both surfaces of the electrode.

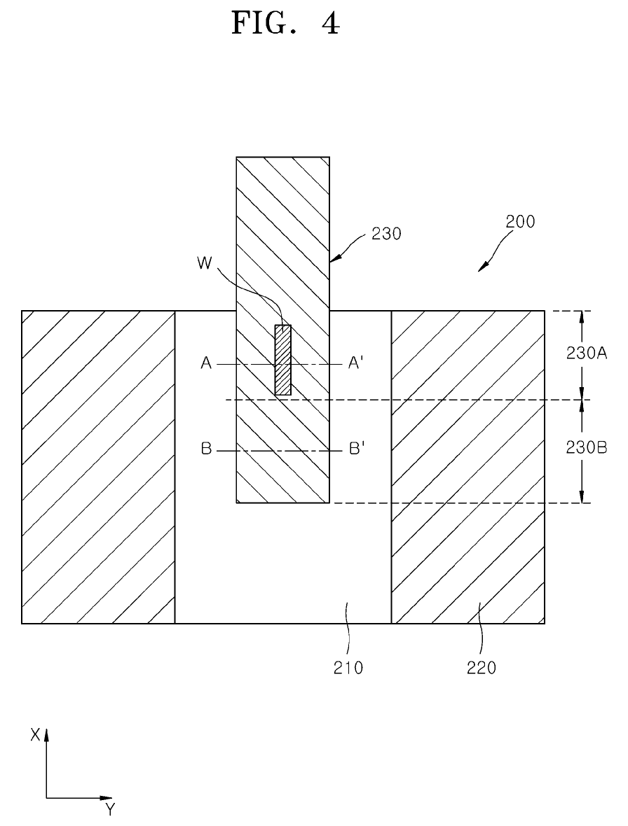

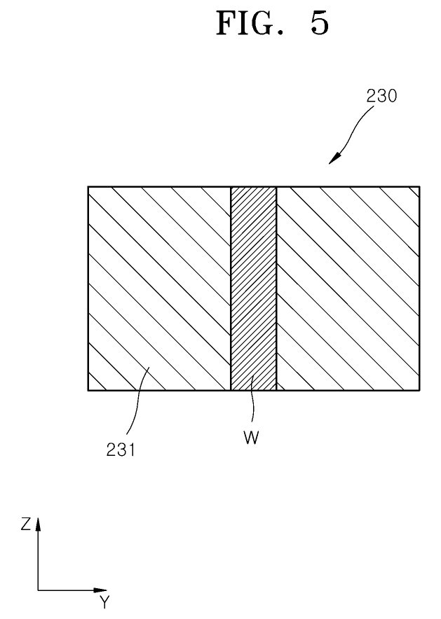

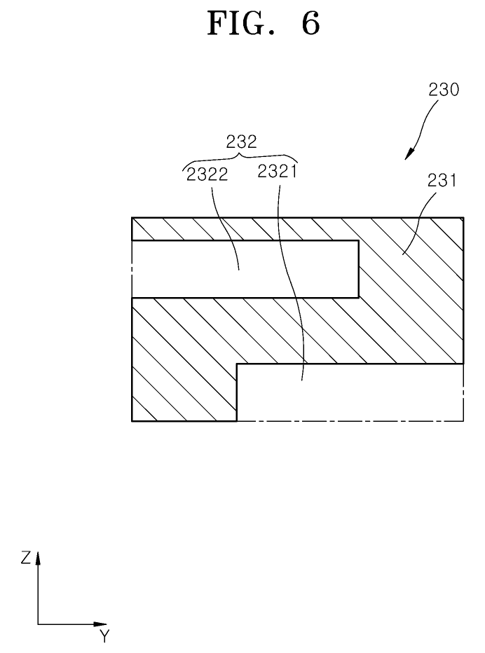

FIG. 4 is a schematic view of an electrode according to an embodiment of the present disclosure. FIG. 5 is a cross-sectional view of a tab taken along line A-A’ in FIG. 4 according to an embodiment of the present disclosure. FIG. 6 is a cross-sectional view of a tab taken along line B-B’ in FIG. 4 according to an embodiment of the present disclosure. FIG. 7 is a cross-sectional view of the tab taken along line B-B’ in FIG. 4 according to an embodiment of the present disclosure.

An electrode 200 according to one embodiment of the present disclosure includes a substrate 210, a mixture layer 220 formed on a portion of the substrate 210, and a tab 230 having an end portion provided on a portion of the substrate and extend from the substrate 210, wherein the tab 230 includes one or more elastic members 250.

The tab 230 may be bonded to the substrate 210 at a bonded portion W. The bonded portion W may be formed by welding the tab 230 and the substrate 210. For example, the bonded portion W may be formed by performing laser welding, ultrasonic welding, high-frequency welding, or the like between the tab 230 and the substrate 210.

As illustrated in FIG. 4, the tab 230 may include a bonded region 230A and a non-bonded region 230B.

The bonded region 230A may include the bonded portion W that is bonded to the substrate 210. The bonded region 230A may be positioned close to the end portion of the tab 230. One or more elastic members 250 may be provided in the non-bonded region 230B. The non-bonded region 230B may be positioned closer to a second end portion of the tab 230 than the bonded region 230A. A groove 232 may be formed in the non-bonded region 230B.

With such a configuration, the tab 230 may be efficiently made to prevent cracks from occurring in the substrate 210 by being divided into the bonded region 230A and the non-bonded region 230B.

FIG. 5 shows a cross-section of the bonded region 230A in the tab 230. As illustrated in FIG. 5, the tab 230 may include a conductive member 231.

The conductive member 231 may form an approximate exterior of the tab 230. The conductive member 231 may be electrically conductive with the substrate 210. The conductive member 231 may include a material that may conduct current, thereby providing a path through which electrons may move from the substrate 210. In some examples, the conductive member 231 may include a metal. The bonded portion W may be formed where the conductive member 231 and the substrate 210 are bonded.

FIG. 6 is a cross-sectional view of the non-bonded region 230B in the tab 230, showing a state before the elastic member 250 is formed in the tab 230.

As illustrated in FIG. 6, the tab 230 may include a groove 232. The groove 232 may be formed in the conductive member 231and/or another portion of the tab 230. The groove 232 may be formed so as not to overlap the bonded portion W. That is, the tab 230 may be bonded to the substrate 210 in an area in which the groove 232 is not formed.

The groove 232 may be an approximately hexahedral shape. However, the shape of the groove 232 is not limited thereto, and may be various other shapes, such as a spherical shape.

The groove 232 may provide a space in which the elastic member 250 is filled. The number, shape and/or size of the grooves 232 may correspond to the number, shape and/or size of the elastic members 250 provided in the groove 232. For example, when there are two or more elastic members 250, a corresponding number of grooves 232 may also be formed. In the depicted example, the groove 232 includes a first groove 2321 and a second groove 2322.

As illustrated in FIG. 7, one or more elastic members 250 may be inserted into the grooves 232. The elastic member 250 may be formed by injection molding in a manner corresponding to the size and/or shape of the groove 232. As such, the elastic member 250 may be inserted into the groove 232 to form a part of the tab 230. Alternatively, the elastic member 250 may be made be injecting a liquid or amorphous state into the groove 232 and then solidified.

The elastic member 250 may include a first elastic member 251. The first elastic member 251 may form a part of a contact surface between the substrate 210 and the tab 230. For example, the first elastic member 251 may form a part of an edge of the contact surface of the substrate 210 and the tab 230. The first elastic member 251 may be positioned on one side of the tab 230 and at one end portion of the tab 230. With such a configuration, the first elastic member 251 may relieve the force that the tab 230 applies to the substrate 210.

The elastic member 250 may include only the first elastic member 251. But in other embodiments, two or more elastic members 250 may be formed. For example, as illustrated in FIG. 7, the elastic member 250 may further include a second elastic member 252.

The second elastic member 252 may be positioned on the other side of the tab 230. That is, the second elastic member 252 may be positioned on opposite side from the first elastic member 251. Thus, the elastic member 250 may ensure that the force that the tab 230 applies to the substrate 210 is uniform on both sides. To this end, the first elastic member 251 and the second elastic member 252 may be the same thickness.

As illustrated in FIG. 7, the second elastic member 252 may be spaced apart from the contact surface of the substrate 210 and the tab 230. Thus, a contact area between the conductive member 231 and the substrate 210 may be increased. Thus, the tab 230 may minimize the resistance occurring between itself and the substrate 210 while also applying a uniform force to the substrate 210 from both sides of the tab 230. In this case, a thickness d of the second elastic member 252 may be less than a thickness D of the tab 230. Further, the thickness d of the second elastic member 252 may be the same as the thickness of the first elastic member 251. Here, the range includes an error range of ±5% or less.

In some embodiments, the second elastic member 252 may also form a part of the contact surface between the substrate 210 and the tab 230. The second elastic member 252 may also form a part of the edge of the contact surface between the substrate 210 and the tab 230.

In FIG. 7, w1 represents the width of the tab 230 and w2 represents the width of the elastic member 250. The width w2 of the elastic member 250 may be formed to be 1% to 99% of the width w1 of the tab 230. In this way, by dividing the tab 230 into the bonded region 230A and the non-bonded region 230B, the elastic member 250 may be formed without limitation as to its size or shape.

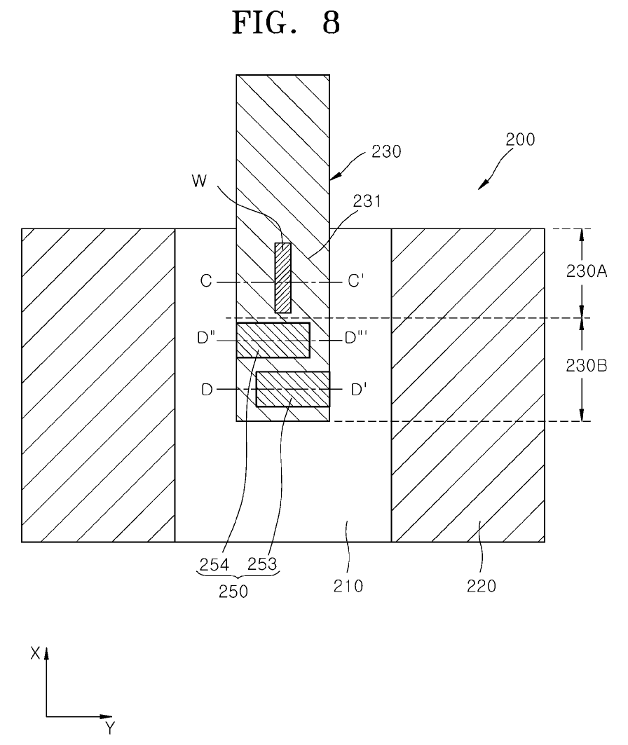

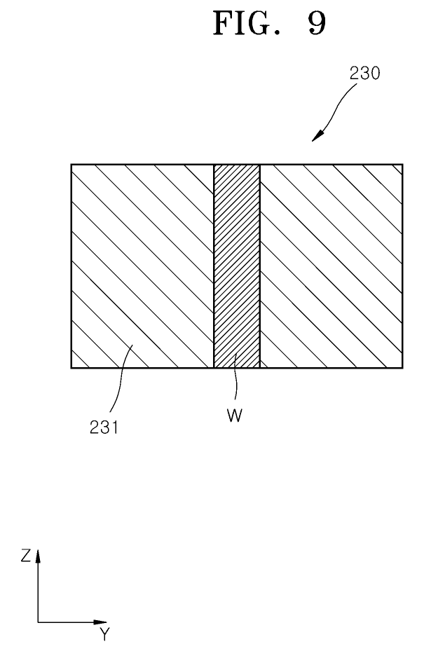

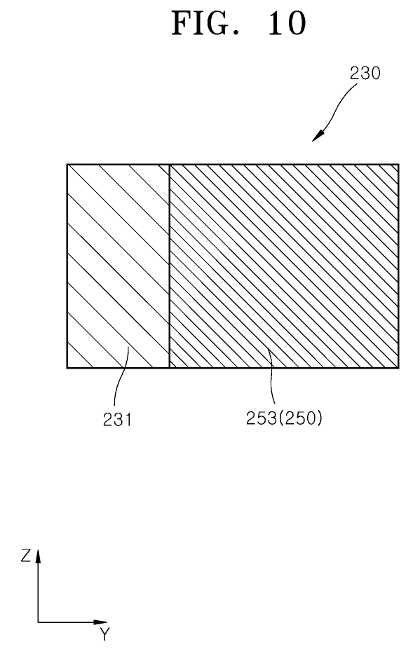

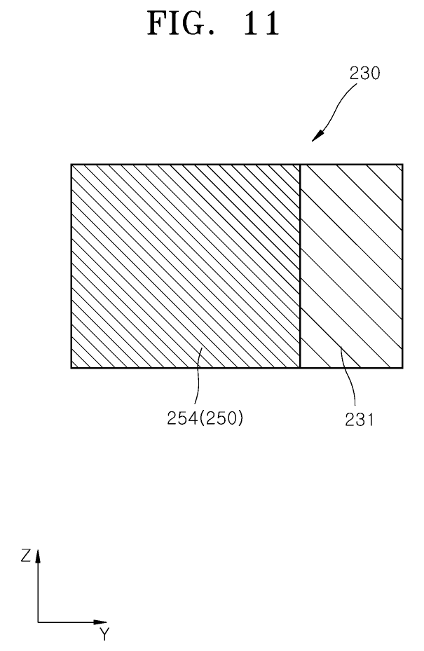

FIG. 8 is a schematic view of an electrode according to an embodiment of the present disclosure. FIG. 9 is a cross-sectional view of a tab taken along line C-C’ in FIG. 8 according to an embodiment of the present disclosure. FIG. 10 is a cross-sectional view of a tab taken along line D-D’ in FIG. 8 according to an embodiment of the present disclosure. FIG. 11 is a cross-sectional view of a tab taken along line D”-D”’ in FIG. 8 according to an embodiment of the present disclosure.

An electrode 200 according to an embodiment of the present disclosure (for example, including the electrode 200 described in FIGS. 1 to 7) includes a substrate 210, a mixture layer 220 formed on a portion of the substrate 210, and a tab 230 having a first end portion provided on the substrate 210 and a second end portion extending from the substrate 210, with the tab 230 including one or more elastic members 250.

The tab 230 may be bonded to the substrate 210 through a bonded portion W as described above with reference to FIGS. 4 to 7. As illustrated in FIG. 8, the tab 230 may include a bonded region 230A and a non-bonded region 230B as also described above.

FIG. 9 is a cross-section view of the bonded region 230A in the tab 230. As illustrated in FIG. 9, the tab 230 may include a conductive member 231. The tab 230 may include a groove 232 formed in the conductive member 231.

FIGS. 10 and 11 are cross-sections view of the non-bonded region 230B in the tab 230.

As illustrated in FIGS. 10 and 11, the tab 230 may include one or more elastic members 250 as describe above.

The elastic member 250 may also include a third elastic member 253. The third elastic member 253 may be positioned on a side of the tab 230. The third elastic member 253 may extend in the width direction of the tab 230 from a side of the tab 230. The third elastic member 253 may form a part of a contact surface between the substrate 210 and the tab 230. The third elastic member 253 may form a part of an edge of the contact surface of the substrate 210 and the tab 230. The third elastic member 253 may be positioned at one end portion on one side of the tab 230. With such a configuration, the third elastic member 253 may relieve the force that the tab 230 applies to the substrate 210.

The elastic member 250 may include only the third elastic member 253. In other embodiment, two or more elastic members 250 may be formed, and the elastic member 250 may further include a fourth elastic member 254, as illustrated in FIGS. 8, 10 and 11.

The fourth elastic member 254 may be positioned on a second side of the tab 230. That is, the fourth elastic member 254 may be positioned opposite to the third elastic member 253. As such, the elastic member 250 may ensure that the force that the tab 230 applies to the substrate 210 is uniform on both sides. The third elastic member 253 and the fourth elastic member 254 may be the same thickness.

The fourth elastic member 254 may extend from the second side of the tab 230 in the width direction of the tab 230. The fourth elastic member 254 may form another part of the contact surface between the substrate 210 and the tab 230 and may form another part of an edge of the contact surface of the substrate 210 and the tab 230.

The third elastic member 253 and the fourth elastic member 254 may be formed with the same thickness. And the third elastic member 253 and/or the fourth elastic member 254 may be formed with the same thickness as the tab 230. As such, the tab 230 may further reduce the force that presses the substrate 210.

The elastic member 250 may include one or more third elastic members 253. The elastic member 250 may include one or more fourth elastic members 254. When there are a plurality of third elastic members 253 and/or fourth elastic members 254, the fourth elastic members 254 may be disposed in an alternating manner with the third elastic members 253. As such, the tab 230 may prevent the contact area with the substrate 210 from becoming excessively narrow. The tab 230 may reduce the resistance with the substrate 210 while lowering the pressing force against the substrate 210.

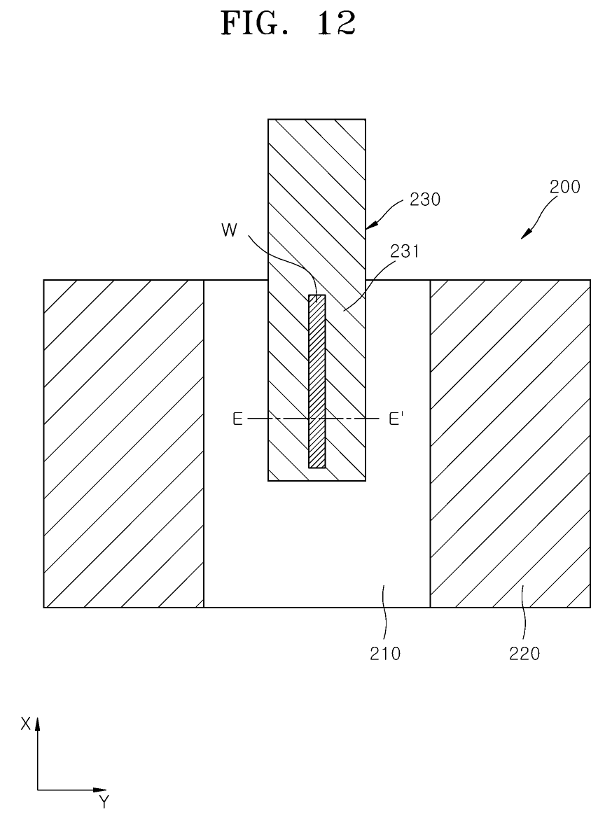

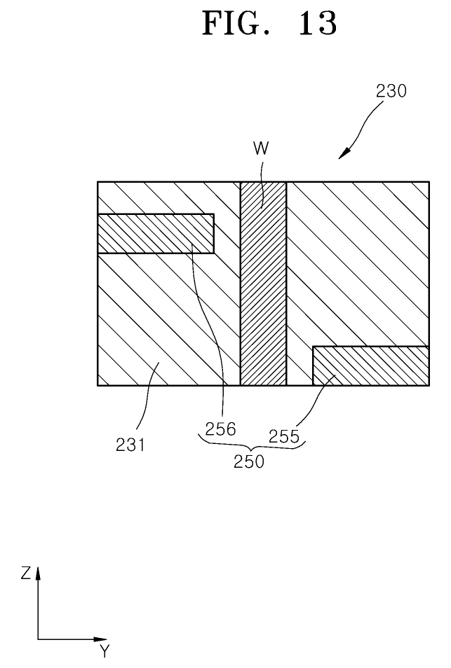

FIG. 12 is a schematic view of an electrode according to an embodiment of the present disclosure. FIG. 13 is a cross-sectional view of a tab taken along line E-E’ in FIG. 12 according to an embodiment of the present disclosure.

An electrode 200 according to an embodiment of the present disclosure includes a substrate 210, a mixture layer 220 formed on a portion of the substrate 210, and a tab 230 having an end portion provided on the substrate 210 and extending from the substrate 210, with the tab 230 including one or more elastic members 250.

The tab 230 may be bonded to the substrate 210 by a bonded portion W. The bonded portion W may be formed in the longitudinal direction of the tab 230. The bonded portion W may be formed over most of the area of the contact surface where the substrate 210 and the tab 230 contact each other. Thus, the substrate 210 and the tab 230 may be more firmly bonded.

As illustrated in FIG. 13, the tab 230 may include a conductive member 231 and a groove 232. The tab 230 may also include one or more elastic members 250.

The elastic member 250 may include a fifth elastic member 255 positioned on a side of the bonded portion W. The fifth elastic member 255 extends from a side of the tab 230 in the width direction of the tab 230. The fifth elastic member 255 may form a part of a contact surface between the substrate 210 and the tab 230 and a part of an edge of the contact surface of the substrate 210 and the tab 230. The fifth elastic member 255 may be positioned at an end portion of the tab 230 on one side of the tab 230. With such a configuration, the fifth elastic member 255 may relieve the force that the tab 230 applies to the substrate 210.

The elastic member 250 may include only the fifth elastic member 255. However, two or more elastic members 250 may be formed, and the elastic member 250 may further include a sixth elastic member 256 as illustrated in FIG. 13.

The sixth elastic member 256 may be positioned on the second side of the bonded portion W. That is, the sixth elastic member 256 may be positioned opposite to the fifth elastic member 255 with the bonded portion W therebetween. With such a configuration, the elastic member 250 may ensure that the force that the tab 230 applies to the substrate 210 is uniform on both sides. Accordingly, the fifth elastic member 255 and the sixth elastic member 256 may be formed with the same thickness.

As illustrated in FIG. 13, the sixth elastic member 256 may be positioned apart from the contact surface of the tab 230. Therefore, a contact area between the conductive member 231 and the substrate 210 may be increased. As such, the tab 230 may minimize the resistance occurring between itself and the substrate 210, while simultaneously applying a uniform force to the substrate 210 from both sides of the tab 230.

The sixth elastic member 256 may also form a part of the contact surface between the substrate 210 and the tab 230. The sixth elastic member 256 may also form a part of the edge of the contact surface between the substrate 210 and the tab 230.

The sixth elastic member 256 may be thinner than the tab 230. Further, the sixth elastic member 256 may be formed with the same thickness as the fifth elastic member 255. In this case, the same range includes an error range of ±5% or less.

With the depicted structure and configuration shown in FIG. 13, the tab 230 may have a wide welding area with the substrate 210 while simultaneously reducing the force applied to the substrate 210.

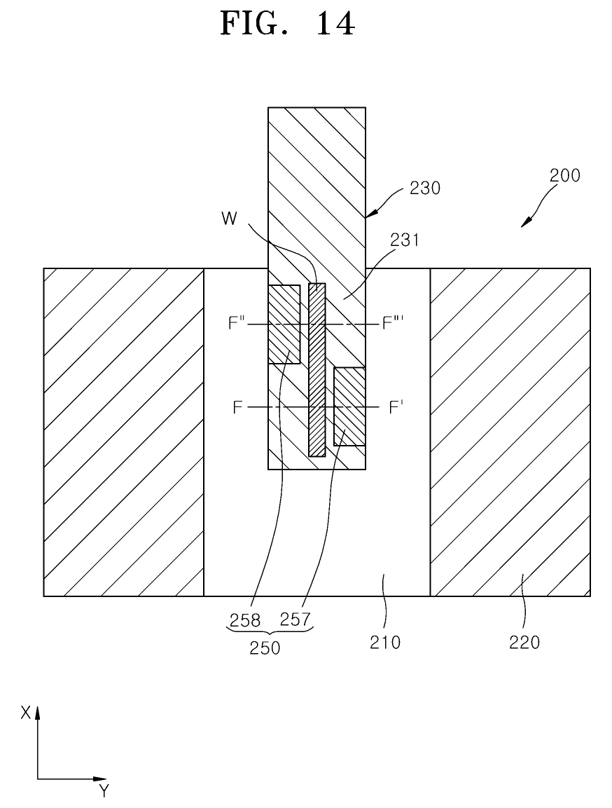

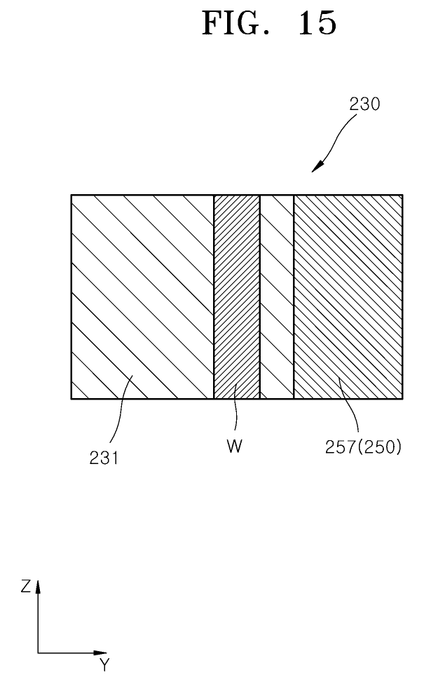

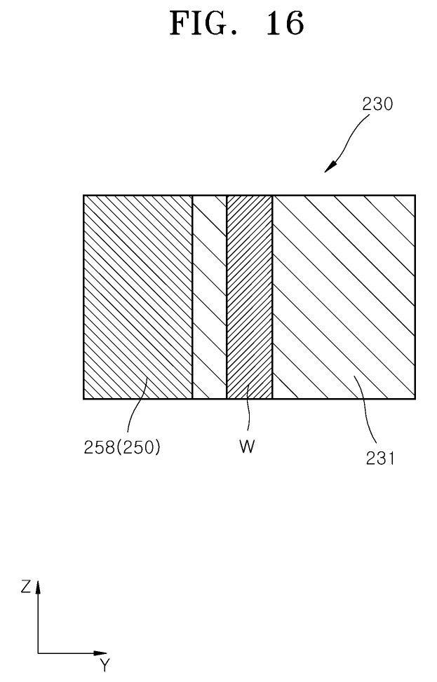

FIG. 14 is a schematic view of an electrode according to one embodiment of the present disclosure. FIG. 15 is a cross-sectional view of a tab taken along line F-F’ in FIG. 14 according to an embodiment of the present disclosure. FIG. 16 is a cross-sectional view of a tab taken along line F”-F”’ in FIG. 14 according to an embodiment of the present disclosure.

An electrode 200 according to one embodiment of the present disclosure includes a substrate 210, a mixture layer 220 formed on a portion of the substrate 210, and a tab 230 having one end portion provided on another portion of the substrate 210 and the other end portion extending from the substrate 210. Here, the tab 230 includes one or more elastic members 250.

The tab 230 may be bonded to the substrate 210 at a bonded portion W. The bonded portion W may be formed along the longitudinal direction of the tab 230 and may be formed over most of the area of the contact surface where the substrate 210 and the tab 230 contact each other. As such, the substrate 210 and the tab 230 may be more firmly bonded.

As illustrated in FIGS. 15 and 16, the tab 230 may include a conductive member 231 and a groove 232. The tab 230 may include one or more elastic members 250.

The elastic member 250 may include a seventh elastic member 257. The seventh elastic member 257 may form a part of a contact surface between the substrate 210 and the tab 230 and the seventh elastic member 257 may form a part of an edge of the contact surface between the substrate 210 and the tab 230. The seventh elastic member 257 may be positioned on one side of the bonded portion W. The seventh elastic member 257 may extend from one side of the tab 230 in the width direction of the tab 230. The seventh elastic member 257 may be positioned at one end portion of the tab 230 on one side of the tab 230. With such a configuration, the seventh elastic member 257 may relieve the force that the tab 230 applies to the substrate 210.

The elastic member 250 may include only the seventh elastic member 257. However, two or more elastic members 250 may be formed, and as illustrated in FIGS. 15 and 16, the elastic member 250 may further include an eighth elastic member 258.

The eighth elastic member 258 may be positioned on the second side of the bonded portion W and extend from the other side of the tab 230 in the width direction of the tab 230. The eighth elastic member 258 may form another part of the contact surface and edge between the substrate 210 and the tab 230.

The seventh elastic member 257 and the eighth elastic member 258 may be formed with the same thickness. Further, the seventh elastic member 257 and/or the eighth elastic member 258 may be formed with the same thickness as the tab 230. Thus, the tab 230 may further reduce the force that presses the substrate 210.

The elastic member 250 may include one or more seventh elastic members 257. The elastic member 250 may include one or more eighth elastic members 258.

When there are a plurality of seventh elastic members 257 and/or eighth elastic members 258, the eighth elastic members 258 may be disposed in an alternating manner with the seventh elastic members 257. With such a configuration, the tab 230 may prevent the contact area with the substrate 210 from becoming too narrow. Also, the tab 230 may reduce the resistance with the substrate 210 while lowering the pressing force against the substrate 210. With this configuration, the tab 230 may have a wide welding area with the substrate 210 while also minimizing the force applied to the substrate 210.

The components of the tab 230 according to one embodiment of the present disclosure are not limited to those described in FIGS. 2 to 16. The tab 230 may be formed as an additional embodiment in addition to the first embodiment described in FIGS. 4 to 7, the second embodiment described in FIGS. 8 to 11, the third embodiment described in FIGS. 12 and 13, and the fourth embodiment described in FIGS. 14 to 16. In addition, the tab 230 may be formed by a combination of two or more of the first embodiment, the second embodiment, the third embodiment, and the fourth embodiment.

According to embodiments of the present disclosure, cracks can be prevented from occurring in a substrate. Further, the safety, reliability and/or lifespan of an electrode and/or a secondary battery can be improved.

However, technical effects acquirable through the present disclosure are not limited to the above-described technical effects, and other technical effects which are not mentioned will be clearly understood by those skilled in the art.

Although the present disclosure has been described with reference to the embodiments shown in the drawings, these embodiments are merely exemplary, and it should be understood by those skilled in the art that various modifications and equivalents are possible.

What is claimed is:

1. An electrode comprising:
a substrate;
a mixture layer formed on a first portion of the substrate; and
a tab having a first end portion provided on a second portion of the substrate and a second end portion spaced from the substrate,
wherein the tab includes one or more elastic members.

2. The electrode of claim 1, wherein the tab includes:
a conductive member that is electrically conductive with the substrate; and
one or more grooves formed in the conductive member and into which the one or more elastic members are inserted.

3. The electrode of claim 1, wherein the one or more elastic members include an elastic member that forms a part of a contact surface between the substrate and the tab.

4. The electrode of claim 3, wherein the elastic member forms a part of an edge of the contact surface between the substrate and the tab.

5. The electrode of claim 3, wherein the elastic member is positioned at the first end portion of the tab.

6. The electrode of claim 3, wherein the elastic member is positioned at a side of the tab.

7. The electrode of claim 6, wherein the elastic member is a first elastic member positioned at a first side of the tab, and
wherein the elastic member includes a second elastic member positioned at a second side of the tab.

8. The electrode of claim 7, wherein the second elastic member is spaced from the contact surface between the substrate and the tab.

9. The electrode of claim 7, wherein the second elastic member forms a part of the contact surface between the substrate and the tab.

10. The electrode of claim 1, wherein the tab includes:
a bonded region bonded to the substrate; and
a non-bonded region where the one or more elastic members are positioned, and
wherein the non-bonded region is positioned closer to the first end portion of the tab than the bonded region is to the first end portion of the tab.

11. The electrode of claim 10, wherein the elastic member includes:
one or more elastic members extending from a first side of the tab in a width direction of the tab; and
one or more elastic members extending from a second side of the tab in the width direction of the tab and alternately disposed with the third elastic members.

12. The electrode of claim 1, wherein the tab is bonded to the substrate at a bonded portion formed in a longitudinal direction of the tab, and
wherein the elastic member includes:
an elastic member positioned on a first side of the bonded portion and extending in a width direction of the tab from a first side of the tab; and
an elastic member positioned on a second side of the bonded portion and extending in the width direction of the tab from a second side of the tab.

13. The electrode of claim 1, wherein the elastic member is formed with a thickness that is less than or equal to a thickness of the tab.

14. The electrode of claim 1, wherein the tab is formed with a thickness of 1 mm or less.

15. The electrode of claim 1, wherein the tab includes:
a first tab provided on a first surface of the substrate; and
a second tab provided on a second surface of the substrate and positioned corresponding to the first tab with the substrate interposed therebetween.

16. A secondary battery comprising:
a case; and
an electrode assembly accommodated in the case, the electrode assembly including a first electrode, a second electrode, and a separator provided between the first electrode and the second electrode,
wherein one or both of the first electrode and the second electrode includes:
a substrate;
a mixture layer formed on a first portion of the substrate; and
a tab having a first end portion provided on a second portion of the substrate and a second end portion spaced from the substrate,
wherein the tab includes one or more elastic members.

17. The secondary battery of claim 16, wherein the one or more elastic members include an elastic member that forms a part of a contact surface between the substrate and the tab.

18. The secondary battery of claim 16, wherein the elastic member forms a part of an edge of the contact surface between the substrate and the tab.

19. The secondary battery of claim 16, wherein the one or more elastic members include:
a first elastic member extending from a first side of the tab in a width direction of the tab; and
a second elastic member extending from a second side of the tab in the width direction of the tab.

20. The secondary battery of claim 16, wherein the tab includes:
a first tab provided on a first surface of the substrate; and
a second tab provided on a second surface of the substrate and corresponding to the first tab with the substrate interposed therebetween.
